(19) United States
(12) Patent Application Publication
(10) Pub. No.: US 2026/0349949 A1
(43) Pub. Date: Nov. 5, 2026

(54) ELECTRONIC DEVICE

(71) Applicant: STMicroelectronics International N.V., Geneva (CH)

(72) Inventors: Mario TOMA, Grrenoble (FR); Nicolas DARBEL, Grenoble (FR); Raphael GUILLAUME, Grenoble (FR)

(73) Assignee: STMicroelectronics International N.V., Geneva (CH)

(21) Appl. No.: 19/662,298

(22) Filed: Apr. 29, 2026

(30) Foreign Application Priority Data
Apr. 30, 2025 (EP) 25315153.4
Oct. 1, 2025 (FR) FR2511305

(51) Int. Cl. G06F 13/38; G06F 1/08

(52) U.S. Cl. CPC G06F 13/387; G06F 1/08; G06F 13/385

(57) ABSTRACT

An electronic device includes a first circuit for converting a first data transfer protocol to a second data transfer protocol. The first circuit includes a first-in, first-out-type storage element for receiving data transferred using the first data transfer protocol. A first frequency of a first clock signal used by the first circuit for conversion is based at least on a second frequency of a second clock signal of the second data transfer protocol and on information relating to a filling of the first-in, first-out-type storage element.

### PRIORITY CLAIM

This application claims the priority benefit of European Application for Patent No. 25315153.4, filed on Apr. 30, 2025; and claims the priority benefit of French Application for Patent No. FR2511305, filed on Oct. 1, 2025, the contents of which are hereby incorporated by reference in their entireties to the maximum extent allowable by law.

### TECHNICAL FIELD

The present disclosure relates generally to electronic devices and methods for transferring data from these electronic devices.

### BACKGROUND

Transporting a standard high-speed communication protocol through a different channel, such as a physically different and non-standard channel, generally requires three steps: first, a protocol conversion (usually digital) from a standard protocol to a different protocol, for example non-standard protocol, second, a transmission through a different channel, for example a non-standard channel (e.g., using a radio frequency channel), and third, a reverse conversion to reconstruct the original standard protocol.

Transmission through the non-standard channel may introduce jitter or require complex implementation.

There is a need to improve the transport of a standard communication protocol, for example high speed, through a non-standard channel.

There is a need to address all or some of the drawbacks of known electronic devices.

### SUMMARY

One embodiment provides an electronic device comprising: a first circuit for converting a first data transfer protocol to a second data transfer protocol; said first circuit comprising a first-in-first-out-type storage element for data transferred using the first data transfer protocol, wherein a first frequency of a first clock signal used by the first circuit for converting is based at least on a second frequency of a second clock signal of the second data transfer protocol and on information relating to a filling of said first-in-first-out-type storage element.

One embodiment provides a method for transferring data from an electronic device, comprising: converting, by a first conversion circuit, a first data transfer protocol to a second data transfer protocol; said first conversion circuit comprising a first-in-first-out-type storage element for data transferred using the first data transfer protocol; and adjusting a frequency of a first clock signal used by the first conversion circuit, based at least on a frequency of a second clock signal of the second data transfer protocol and on information relating to filling said first-in-first-out-type storage element.

According to one embodiment, the device comprises a second circuit and a generator of the first clock signal; wherein the generator is configured to generate the first clock signal based on a setpoint from the second circuit; and wherein the second circuit is configured to determine said information relating to the filling of said first-in-first-out-type storage element and to generate said setpoint from said information relating to the filling of said first-in-first-out-type storage element.

According to one embodiment, said information relating to the filling of said first-in-first-out-type storage element is determined based on a filling rate and an output rate of said first-in-first-out-type storage element.

According to one embodiment, said first-in-first-out-type storage element is configured to be half-filled in an initialization phase.

According to one embodiment, said information relating to the filling of said first-in-first-out-type storage element is determined based on a variation in said filling over a given time.

According to one embodiment, said information relating to the filling of said first-in-first-out-type storage element is determined according to read pointers of said first-in-first-out-type storage element.

According to one embodiment, the first frequency is adapted to be higher than the second frequency when said value relating to the filling of said first-in-first-out-type storage element is higher than a first threshold, and lower than the second frequency when said value relating to the filling of said first-in-first-out-type storage element is lower than a second threshold.

According to one embodiment, the second frequency is configured to vary periodically.

According to one embodiment, when the second frequency is configured to vary according to a spread spectrum clock protocol, then the first frequency is adapted according to said spread spectrum clock protocol.

According to one embodiment, the first frequency is based on the second frequency to which a value based on information relating to the filling of said first-in-first-out-type storage element is added or subtracted.

According to one embodiment, the first frequency is updated when said value based on information relating to the filling of said first-in-first-out-type storage element varies beyond a threshold.

According to one embodiment, after updating the first frequency, a given period of time is observed before said information relating to the filling of said first-in-first-out-type storage element is determined once again.

According to one embodiment, said first-in-first-out-type storage element is a memory or a register bank.

According to one embodiment, said second data transfer protocol is a protocol from the group comprising USB3®, USB4®, DisplayPort®, and Ethernet®.

According to one embodiment, said first data transfer protocol is implemented by a radio frequency channel, or an optical channel, or a waveguide, coupled to an input of the first-in-first-out-type storage element.

According to one embodiment, said first frequency is additionally based on measured, determined, or predetermined information relating to the second data transfer protocol.

According to one embodiment, the first frequency is adjusted so that the first-in-first-out-type storage element is never empty and never full.

According to one embodiment, the device comprises a first apparatus and a second apparatus; the first apparatus comprising: a first physical interface implementing the second data transfer protocol, and configured to be coupled to a connector compatible with the second data transfer protocol; a third circuit, coupled to the first physical interface and configured to implement a conversion from the second data transfer protocol to the first data transfer protocol; and a radio frequency transmitter for the radio frequency channel, coupled to the second circuit, and using the first data transfer protocol; the second apparatus comprising: a radio frequency receiver of the radio frequency channel and using the first data transfer protocol; the first circuit, coupled to the radio frequency receiver; a second physical interface implementing the second data transfer protocol and configured to be coupled to a connector compatible with the second data transfer protocol.

According to one embodiment, said measured information relating to the second data transfer protocol is measured in the first apparatus and transferred to the second apparatus, via the channel, for use by the first circuit.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically illustrates, in the form of functional circuits, an example of a data transfer chain to which the embodiments may be applied;

FIG. 2 schematically illustrates, in the form of functional circuits, an embodiment of the data transfer chain shown in FIG. 1;

FIG. 3 illustrates a data transfer method implemented in FIG. 2; and

FIG. 4 schematically illustrates, in the form of functional circuits, an example of a data transfer chain shown in FIG. 1.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms "front", "back", "top", "bottom", "left", "right", etc., or to relative positional qualifiers, such as the terms "above", "below", "higher", "lower", etc., or to qualifiers of orientation, such as "horizontal", "vertical", etc., reference is made to the orientation shown in the figures.

Unless specified otherwise, the expressions “about”, “around”, “approximately”, “substantially” and “in the order of” signify within 10 % or 10°, and preferably within 5 % or 5°.

In the text: a serial link is defined as a communication channel where information is sent sequentially, one bit at a time; jitter is defined as a temporal variation in a set of signal edges relative to their ideal value (i.e., aligned with a reference clock signal); a retimer is defined as a standardized component capable of retransmitting a serial signal, such as USB3®/USB4® type, improving signal quality and enabling longer communication distances; and a phase-locked loop (PLL) is defined as a component or circuit used to generate a clock signal with a desired frequency from a reference clock signal and a multiplication factor.

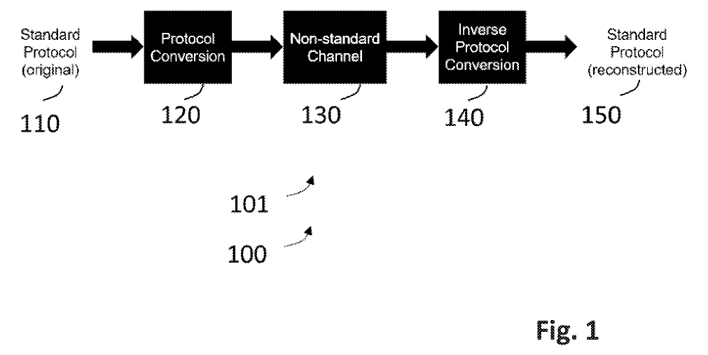

FIG. 1 very schematically illustrates, in the form of functional circuits, an example of a data transfer chain 101 to which the modes of implementation may be applied. The transfer chain 101 is, for example, implemented within a device 100.

The transfer chain 101 in FIG. 1 comprises the transport of a high-speed communication protocol 110 (Standard Protocol (original)), such as a high-speed serial link (~10Gbps), USB3®, USB3.2®, USB4®, DisplayPort®, Ethernet®, through a different channel 130. Channel 130 is, for example, physically different from protocol 110 and/or uses, for example, a non-standard (or Non-Standard) data protocol or a standard data protocol that is different from communication protocol 110. For the sake of simplification, in the text, channel 130 is also referred to as non-standard channel 130. The non-standard channel 130 is, for example, a radio frequency channel, an optical channel, or a waveguide.

A standard protocol means, for example, a protocol that is standardized or widely used and documented, as opposed to a proprietary or customized protocol, which may represent a type of non-standard or Non-Standard protocol.

In the text, the term protocol refers equally to the data transferred by this protocol.

In the example in FIG. 1, the transport of communication protocol 110, in other words the transport of data according to communication protocol 110, includes a step for converting protocol 110 to a non-standard protocol used by channel 130 (Non-standard Channel). This conversion is implemented, for example, by a conversion circuit 120 (Protocol Conversion). The conversion is implemented, for example, using digital or analog or mixed signal processing.

In the example shown, once the conversion has been performed, the converted protocol, in other words the data converted from the standard protocol to the non-standard protocol used by channel 130, is transmitted through channel 130.

The transmitted protocol, in other words the data transmitted with the non-standard protocol, undergoes, with a reconversion circuit 140 (Inverse Protocol Conversion), a reconstruction 150 (Standard Protocol (reconstructed)), in other words a reconversion, to the original standard protocol 110, in other words data transmitted with the standard protocol.

Common serial protocols such as USB3®, USB3.2®, USB4®, DisplayPort®, Ethernet®, ..., allow data to be transported alone, for example one bit at a time. However, these protocol data streams do not transport the original clock signal used to generate the data being transported.

To correctly reconstruct the data bits, the original clock signal used to generate the data transport must be reconstructed, for example by a receiver using a clock signal reconstruction component called CDR (Clock Data Recovery) circuit. However, the reconstructed clock signal is generally degraded compared to the original clock signal used to generate data transport.

For example, channel 130, which uses a non-standard protocol, only transports the data and not the associated clock signal. This may require the use of a CDR clock signal reconstruction circuit.

Channel 130 may also introduce additional jitter, which can further degrade the quality of the reconstructed clock signal.

The quality of the clock signal is specified for each of the standard protocols USB3®, USB3.2®, USB4®, DisplayPort®, Ethernet®, ..., with jitter as the main parameter. The clock signal used for reconversion is reconstructed from the input data that has passed through channel 130, so the jitter introduced by channel 130 degrades the jitter of the reconstructed clock signal. If the associated jitter becomes too large, the reconstructed signal would become incompatible with the maximum jitter level required by the associated standard.

One possible solution could be to use USB3®/USB3.2®/USB4® resynchronizers or DisplayPort® repeaters, for example. However, this solution is not compatible with the use of channel 130.

Other possible solutions could be: implementing a conversion using a reconstructed version of the original clock signal obtained by a CDR reconstruction component; or implementing a conversion using an independent, undegraded clock signal that would have the same nominal frequency (specified in the standard) as the original clock signal; in this case, the residual differences between clock signals are compensated for by adding or deleting specific SKIP symbols that are defined in the standard for this purpose.

In the case of audio data embedded in a video stream, the clock signal associated with the audio data is not available on the receiving end of channel 130 and cannot be reconstructed directly from the data transmitted through channel 130. To overcome this, an audio clock signal is thus generated using a digital algorithm from a faster reference clock signal and using timestamps injected into the audio stream. However, this solution is only possible because of the low frequency of audio signals.

In the case of a radio frequency channel where the standard protocol uses spread spectrum clocking (SSC), this degrades the radio frequency jitter budget, leading to complexity and increased power consumption.

These methods are not agnostic with regard to different types of standards and only work if SKIP symbols are present as defined in the standards.

In order to overcome these issues, the embodiments described are based on a procedure allowing the generation of the clock signal used for conversion to be dynamically controlled.

The embodiments described thus provide for an electronic device comprising a first circuit (140) for converting a first data transfer protocol to a second data transfer protocol (110, 150); said first circuit (140) comprising a first-in, first-out (FIFO)-type storage element for data transferred using the first (non-standard) data transfer protocol; a frequency of a first clock signal (Retransmission_Clock), used by the first circuit (140) for conversion, being based at least on a frequency of a second clock signal (Source_Clock) of the second data transfer protocol (110, 150) and on information relating to the filling of said storage element.

In the following text, the first data transfer protocol is also referred to as a non-standard protocol, or non-standard data transfer protocol, or channel protocol, or non-standard channel protocol. In addition, the second data transfer protocol is also referred to as a standard protocol, or reconstructed standard protocol.

The embodiments are thus based on a negative feedback loop the feedback of which varies according to the filling state of the storage element. This feedback loop thus allows the frequency of the first clock signal to be modified according to information relating to the filling state of the storage element.

This further allows cases where data is processed in bursts to be addressed.

Another advantage is that the frequency of the clock signal used in the non-standard channel 130 can be higher than the clock signal used in the standard protocol. This allows time multiplexing of multiple data streams.

The described embodiments further allow the quality of the clock signal used by circuit 140 to reconstruct the data received by channel 130 to be improved.

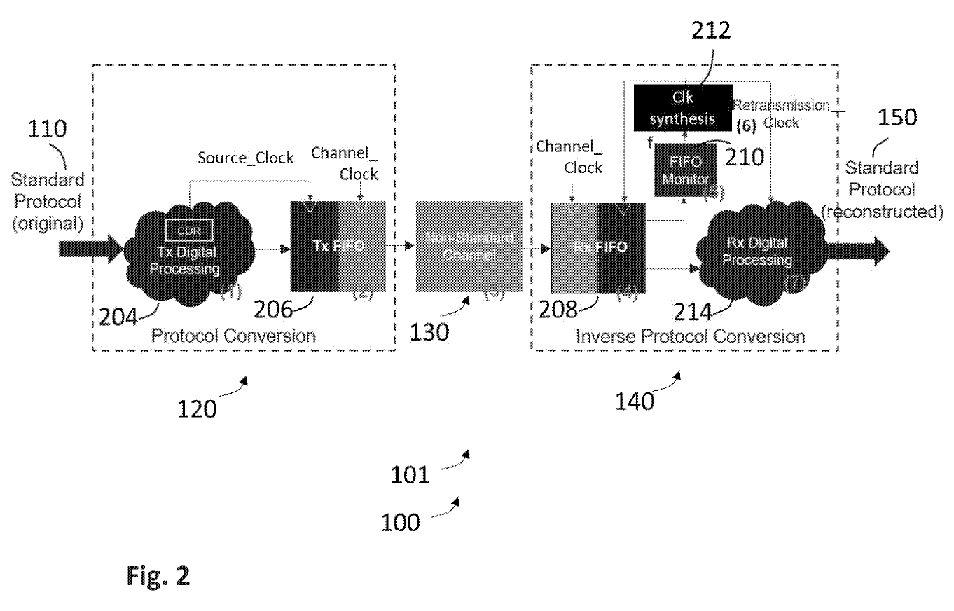

FIG. 2 schematically illustrates, in the form of functional circuits, an embodiment of the data transfer chain shown in FIG. 1.

In the example shown, conversion circuit 120 comprises functional circuit 204 (Tx Digital Processing) and functional circuit 206 (Tx FIFO).

In the example shown, circuit 204 is configured to receive data using the standard data transfer protocol 110 (such as one of the USB3/USB4/DisplayPort/Ethernet protocols). Circuit 204 is configured to process, for example digitally, the conversion from the standard serial protocol 110 to the non-standard protocol used by channel 130.

Circuit 204 comprises, for example, a clock signal reconstruction sub-circuit or component (CDR) capable of recovering the source clock signal (Source_Clock) used to generate the incoming data stream of the standard protocol 110. The original, or source, clock signal detected by the CDR component is supplied to circuit 206. Circuit 206 also receives as input a channel clock signal (Channel_Clock) specific to the non-standard channel 130.

Circuit 206 implements the transition from the source clock signal (Source_Clock) to the channel 130 clock signal. The source clock signal (Source_Clock) and the channel 130 clock signal (Channel_Clock) are independent. In one example, the channel 130 clock signal is faster than the source clock signal, which prevents data loss.

Circuit 206 is, for example, a storage element, such as a register bank, a register, or a first-in, first-out (FIFO)-type memory. In the event that the channel 130 clock signal is faster than the source clock signal, the storage element 206 may be temporarily empty since the incoming data will fill it less quickly than the data output speed.

In the example shown, the non-standard channel 130 comprises, for example, a transceiver and means for physically transmitting. In one example, the transceiver is a radio frequency transceiver for over-the-air communication, or an optical transceiver for fiber optic communication. Channel 130 is, for example, implemented independently of circuit 204, i.e., the standard protocol used at the input of circuit 120 or by circuit 204 is not used by channel 130. In particular, the channel 130 clock signal and the source clock signal are, for example, independent from each other.

In the example where storage element 206 becomes empty, channel 130 is configured, for example, so as not to corrupt the data while attempting to read the contents of storage element 206.

In one example, a transmitter circuit of channel 130 may insert symbols, for example IDLE, which are then removed by a receiver circuit of channel 130 at the end of transmission by the channel. The transmitter circuit of channel 130 may further insert data from a low-speed channel, for example. In other words, in the case where channel 130 has a sufficiently high frequency, for example higher than that of the source clock signal (Source_Clock), it is then possible to transport additional data, for example not included in standard protocol 110, through channel 130. This additional data is then removed, for example, by the receiver of channel 130 before entering circuit 140.

In the example shown, circuit 140 comprises a storage element 208 (Rx FIFO) that receives data arriving from channel 130 at the rate of the channel clock signal (Channel_Clock). Storage element 208 is, for example, a register bank, a register, or a first-in, first-out (FIFO)-type memory. The data enters the storage element 208 at the rate of the channel 130 clock signal, and exits at the rate of a clock signal known as the retransmission or reconversion clock (Retransmission_Clock).

Circuit 140 comprises, for example, a clock signal generator 212 (Clk synthesis) configured to generate the retransmission clock signal (Retransmission_Clock) based on a frequency setpoint f. The generator 212 comprises, for example, an oscillator, and/or a phase-locked loop, and/or a fractional phase-locked loop, and/or a phase interpolation circuit based on a fixed clock signal.

In the example shown, circuit 140 comprises a functional circuit 210 (FIFO Monitor) which is configured to determine the value of the frequency setpoint f to be sent to generator 212 based on information relating to the filling of storage element 208, such as a filling level or fill rate.

In one example, circuit 210 is coupled to, or forms part of, generator 212. Circuit 210 is configured, for example, to modify, and/or modulate, and/or adjust, the value of the frequency setpoint f, or setpoint of frequency f, based on information (information that may contain multiple data items) relating to a level, or rate, of filling of the storage element 208, and based on other information or values.

In one example, the information relating to the filling of the storage element 208 is determined based on a rate, or throughput, of data input to the storage element 208 and on a rate, or throughput, of data output from the storage element 208.

In one example, the information relating to the filling of the storage element 208 is determined based on a variation in the filling level of the storage element 208 over a given time.

In one example, information relating to the filling of storage element 208 is determined based on read pointers of storage element 208.

In one example, a frequency of the retransmission clock signal (Retransmission_Clock) is higher than a frequency of the channel 130 clock signal (Channel Clk).

In another example, the frequency of the retransmission clock signal (Retransmission_Clock) is lower than the frequency of the channel 130 clock signal (Channel Clk). In this case, it is possible to send more data through channel 130 than is required by standard protocol 110.

In one example, storage element 208 is half-filled in an initialization phase.

In one example, the frequency setpoint f is based on a frequency of the channel 130 clock signal (Channel Clk) to which a value based on information relating to the filling level of storage element 208 is added or subtracted. For example, if the filling level of storage element 208 increases, then circuit 210 will increase frequency setpoint f so that the frequency of the retransmission clock signal (Retransmission_Clock) generated by generator 212 is higher than the frequency of the channel 130 clock signal (Channel Clk). Conversely, if the filling level of storage element 208 decreases, and optionally becomes less than half of storage element 208, then circuit 210 will decrease the frequency setpoint f so that generator 212 decreases the frequency of the conversion clock signal (Retransmission_Clock).

In one example, the frequency setpoint f is updated by circuit 210 when a value of the filling level of storage element 208 has a variation greater than a threshold.

In one example, the frequency setpoint f is based, in addition to the filling level of storage element 208, on information extracted or measured from the standard data transfer protocol, such as information on a maximum bit transmission rate. In one example, this information from the standard data transfer protocol is sent through channel 130 and optionally updated dynamically. In one example where the Source_Clock signal is modulated by varying the frequency over time in accordance with spread spectrum clocking (SSC), information concerning the frequency modulation of the Source_Clock signal may be sent through channel 130 to adjust the frequency setpoint f.

In one example, the frequency setpoint f is adjusted so that the storage element 208 is never empty and never full.

In one example, the frequency setpoint f is updated by circuit 210 based on information relating to the filling level of storage element 208, and then a given period of time is observed before the information relating to the filling level of the storage element is again determined by circuit 210 and sent to generator 212. This allows for a stabilization time.

In one example, circuit 210 receives information from storage element 208 indicating the filling level "C" of storage element 208, one or more filling thresholds, such as a filling threshold called "F" indicating that storage element 208 is almost full or a filling threshold called "E" indicating that storage element 208 is almost empty. The filling level "C" of the storage element 208 is obtained, for example, by evaluating the number of elements or data stored in the storage element 208 at a given time, as well as their size, and comparing this to the total size of the storage element 208.

In one example, circuit 210 delivers the value of the setpoint frequency f to generator 212, for example based on elements "C," "F," or "E," and the frequency f_{DEFAULT} of the source clock signal (Source_Clock), so that the latter generates the conversion clock signal with this value of frequency setpoint f. By default, for example during an initialization phase, the frequency f is equal to the frequency f_{DEFAULT} of the source clock signal (Source_Clock), which is known because it is specified in the standard protocol. The frequency f is, for example, dynamically updated by circuit 210 to compensate for residual differences between the source clock signal (Source_Clock) and the reconversion clock signal (Retransmission_Clock).

The combination of circuit 210 and generator 212 allows the data output speed of storage element 208 to be controlled based on data relating to its filling level, which ultimately allows it to be adapted to the jitter inherent in non-standard channel 130 or to other disturbances. The retransmission clock signal (Retransmission_Clock) thus has low jitter. Indeed, the retransmission clock signal (Retransmission_Clock) being independent of the channel 130 clock signal does not inherit its jitter.

In the example shown, the output of circuit 208 and the output of generator 212 are coupled to a functional circuit 214 (Rx Digital Processing) for standard protocol reconstruction, for example by digital or analog or mixed signal processing operations. Circuit 214 receives the data from the output of storage element 208 as well as the conversion clock signal (Retransmission_Clock). From these elements, circuit 214 reconstructs the standard protocol, in other words, circuit 214 reconstructs the output data from storage element 208 in the standard protocol format.

Circuit 214 outputs data 150 (Standard Protocol (reconstructed)) in a serial link format compatible with the original standard protocol 110 (such as USB3/USB4/DisplayPort/Ethernet).

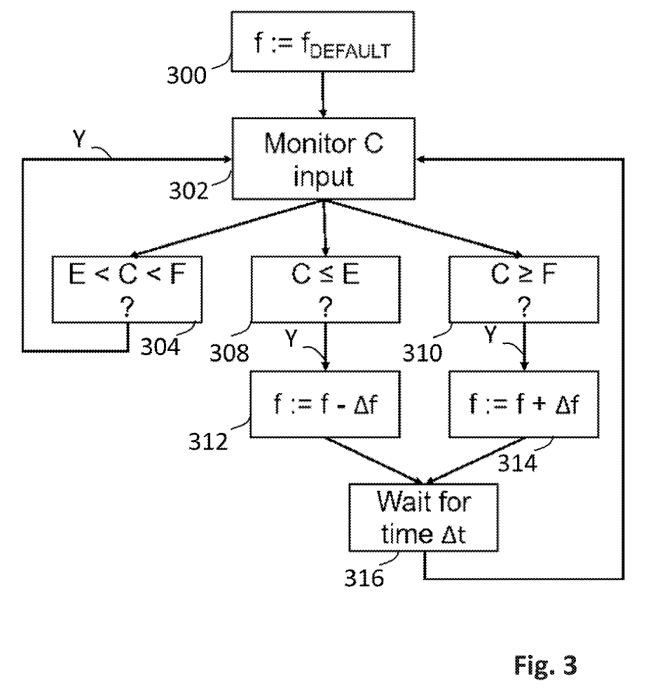

FIG. 3 illustrates a method for transferring data implemented in FIG. 2 according to one embodiment. More specifically, the illustrated example represents an example operation of circuit 210 and generator 212.

In an optional step 300 (f:=f_{DEFAULT}), the frequency setpoint f indicated to generator 212 by circuit 210 corresponds to the frequency f_{DEFAULT} of the source clock signal (Source_Clock), which is known because it is specified in the standard protocol.

In a step 302 (Monitor C input), for example subsequent to step 300, circuit 210 acquires the current filling level "C" of storage element 208. In one example, this filling level is determined based on read pointers.

In steps 304 (E<C<F?), 308 (E≤C?), 310 (C≥F) subsequent to step 302, circuit 210 compares the determined value of C with thresholds E and/or F.

In step 304, if the filling level "C" of storage element 208 is strictly between thresholds E and F (branch Y), then the current value of the frequency setpoint f, and therefore the output frequency of generator 214, is not changed and step 302 is implemented, after waiting for a certain period of time, for example.

In step 308, if the filling level "C" of the storage element 208 is less than or equal to threshold E, then (branch Y) step 312 (f:=f-Δf) is implemented.

In step 310, if the filling level "C" of storage element 208 is greater than or equal to threshold F, then (branch Y) step 314 (f:=f+Δf) is implemented.

In step 312, the current value f is decreased by a value Δf which is, for example, predetermined by programming. This makes it possible to decrease the output frequency of the generator and thus decrease the output rate of data from storage element 208.

In step 314, the current value f is increased by the value Δf, which is, for example, equal to or different from that of step 312, and which is, for example, predetermined by programming. This increases the output rate of data from storage element 208 so that the filling level of storage element 208 is more or less close to half.

Following steps 312 or 314, an optional step 316 (Wait for time Δt) is implemented. In step 316, after the value f has been updated by circuit 210, step 302 is implemented but waiting for a time Δt so that the frequency variation of the clock signal at the output of the generator does not exceed Δf/Δt. This is required for many applications because the maximum value of this parameter is defined by the original standard, for example. Another reason is that too high a value of Δf/Δt can cause clock reconstruction problems for a downstream CDR circuit (i.e., in the standard protocol circuit 150 that receives the reconstructed signal).

The examples shown in FIGS. 2 and 3 allow the frequency of the reconversion clock signal (Retransmission_Clock) to be synchronized to the frequency at which data arrives at the input of storage element 208.

The examples shown in FIGS. 2 and 3 further allow using a non-standard channel that is completely independent of the standard 110 protocol, in other words, they are referred to as "orthogonal”.

The examples shown in FIGS. 2 and 3 also allow the standard protocol used to implement spread spectrum clocking (SSC).

The examples shown in FIGS. 2 and 3 also have the advantage of offering a parametric solution since parameters such as the size of storage element 208, thresholds E and F, and elements Δf and Δt are configurable. These parameters can be adjusted to modify the transmission latency of the transmission chain or the characteristics of the conversion clock signal.

The examples shown in FIGS. 2 and 3 allow for robust reconstruction of the conversion clock signal even though the channel 130 clock signal (Channel_Clock) is faster than the standard protocol clock signal (Source_Clock), which opens the door to new applications such as time multiplexing of multiple data streams.

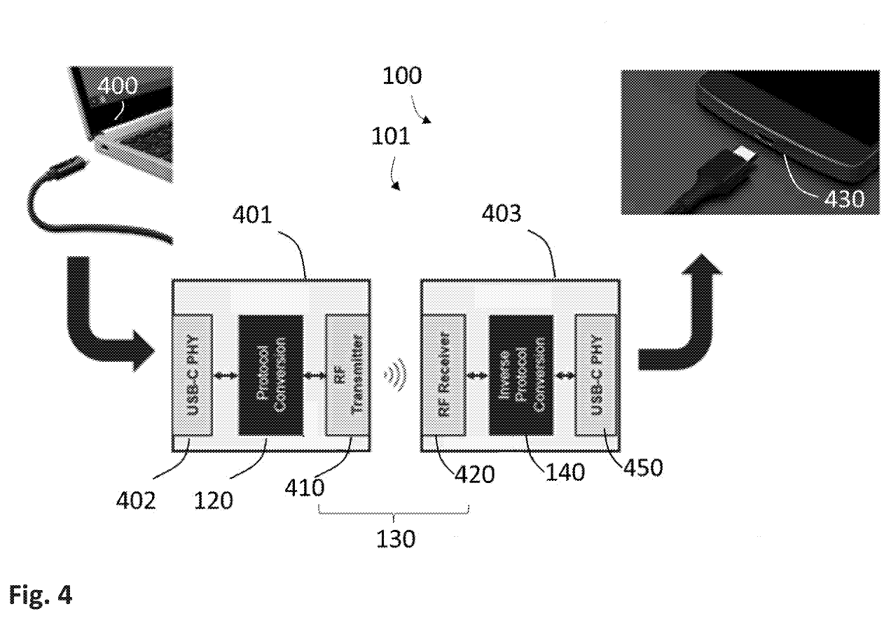

FIG. 4 schematically illustrates, in the form of functional circuits, an example of the data transfer chain 101 shown in FIG. 1 according to one embodiment. The data transfer chain 101 shown in FIG. 4 ensures the transmission of data between an electronic device 400 (here a computer) and an electronic device 430 (here a smartphone).

The data transfer chain 101 shown in FIG. 4 comprises two electronic devices 401, 402 communicating with each other wirelessly through the radio frequency channel 130.

In the example shown, the computer 400 is coupled with a USB3 (or USB-C) type USB cable to a USB-C- (or USB-3-) type physical interface 402 (USB-C PHY) of the electronic device 401, where the standard USB3 protocol is implemented.

In the example shown, the physical interface 402 is coupled to the conversion circuit 120, which is similar or identical to that shown in FIGS. 1 or 2.

In the transmission chain 101 of FIG. 4, the non-standard channel 130 comprises a transmitter circuit 410 (RF Transmitter), implemented in the device 401, which modulates and transmits modulated radio frequency waves taking into account the non-standard protocol following the protocol conversion implemented by circuit 120. The non-standard channel 130 further comprises a receiver circuit 420 (RF Receiver), implemented in device 403, which receives, demodulates, and processes the radio frequency waves received from device 401.

In the example shown, circuit 420 is coupled to circuit 140 implemented in device 403. At the output of the conversion circuit 140, the standard protocol USB-C, initially present at the input of device 401, is reconstructed and sent to a USB-C- (or USB-3-) type physical interface 450 (USB-C PHY) of electronic device 403, where the standard protocol USB3 is implemented.

In the example shown, a USB-C- or USB3-type cable couples the physical interface 450 to the electronic device 430.

The example in FIG. 4 allows, for example, fast and robust data transfer using a non-standard protocol between two electronic devices using standard serial protocols.

Various embodiments and variants have been described. Those skilled in the art will understand that certain features of these embodiments can be combined and other variants. In particular, circuit 210 and generator 212 can be implemented as a single circuit.

Finally, the practical implementation of the embodiments and variants described herein is within the capabilities of those skilled in the art based on the functional description provided hereinabove. In particular, those skilled in the art will be able to adapt the frequency setpoint f based not only on information relating to the filling of storage element 208, but also on other information relating to the operation of the non-standard channel or standard protocol 110.

Applications of the described embodiments include, for example, automotive field, or any application requiring the transfer of a standard protocol through a non-standard protocol.

1. An electronic device, comprising:
a first circuit configured to convert data transferred according to a first data transfer protocol to data transferred according to a second data transfer protocol, wherein said first circuit comprises:
a first-in, first-out-type storage element having an input configured to receive the data transferred according to the first data transfer protocol;
wherein a first frequency of a first clock signal used by the first circuit to convert the data is based at least on a second frequency of a second clock signal of the second data transfer protocol and on information relating to a filling of said first-in, first-out-type storage element.

2. The device according to claim 1, further comprising:
a second circuit; and
a generator of the first clock signal, wherein the generator is configured to generate the first clock signal based on a setpoint generated by the second circuit; and
wherein the second circuit is configured to determine said information relating to the filling of said first-in, first-out-type storage element and generate said setpoint from said information relating to the filling of said first-in, first-out-type storage element.

3. The device according to claim 1, wherein said information relating to the filling of said first-in, first-out-type storage element is determined based on a filling rate and an output rate of said first-in, first-out-type storage element.

4. The device according to claim 3, wherein said first-in, first-out-type storage element is configured to be half-filled in an initialization phase.

5. The device according to claim 1, wherein said information relating to the filling of said first-in, first-out-type storage element is determined based on a variation in said filling over a given time.

6. The device according to claim 1, wherein said information relating to the filling of said first-in, first-out-type storage element is determined according to read pointers of said storage element.

7. The device according to claim 1, wherein the first frequency is greater than the second frequency when said value relating to the filling of said first-in, first-out-type storage element is greater than a first threshold, and is less than the second frequency when said value relating to the filling of said first-in, first-out-type storage element is less than a second threshold.

8. The device according to claim 7, wherein the second frequency is configured to vary periodically.

9. The device according to claim 8, wherein the second frequency is configured to vary according to a spread spectrum clock protocol, and wherein the first frequency is adapted according to said spread spectrum clock protocol.

10. The device according to claim 1, wherein the first frequency is based on the second frequency to which a value based on information relating to the filling of said first-in, first-out-type storage element is added or subtracted.

11. The device according to claim 10, wherein the first frequency is adjusted so that said first-in, first-out-type storage element is never empty and never full.

12. The device according to claim 10, wherein the first frequency is updated when said value based on the information relating to the filling of said first-in, first-out-type storage element varies beyond a threshold.

13. The device according to claim 12, wherein, after updating the first frequency, there is a delay for a given period of time before said information relating to the filling of said first-in, first-out-type storage element is determined again.

14. The device according to claim 1, wherein said first-in, first-out-type storage element is one of a memory or a register bank.

15. The device according to claim 1, wherein said second data transfer protocol is a protocol from the group consisting of USB3®, USB4®, DisplayPort®, and Ethernet®.

16. The device according to claim 1, wherein said first data transfer protocol is implemented by one of a radio frequency channel, an optical channel, or a waveguide, that is coupled to an input of said first-in, first-out-type storage element.

17. The device according to claim 1, wherein said first frequency is additionally based on measured, determined, or predetermined information relating to the second data transfer protocol.

18. A device, comprising:
a first apparatus comprising:
a first physical interface implementing a standard data transfer protocol and configured to be coupled to a connector compatible with the standard data transfer protocol;
a first conversion circuit coupled to the first physical interface and configured to implement a conversion from the standard data transfer protocol to a non-standard data transfer protocol; and
a transmitter of a non-standard channel coupled to an output of the first conversion circuit and configured to use the non-standard data transfer protocol; and
a second apparatus comprising:
a receiver of the non-standard channel and configured to use the non-standard data transfer protocol;
a second conversion circuit coupled to the receiver and configured to implement a conversion from the non-standard data transfer protocol to the standard data transfer protocol;
a second physical interface implementing the standard data transfer protocol and configured to be coupled to a connector compatible with the standard data transfer protocol;
wherein the second conversion circuit comprises a circuit configured to convert data transferred according to the non-standard data transfer protocol to data transferred according to the standard data transfer protocol, wherein said circuit for converting comprises:
a first-in, first-out-type storage element having an input configured to receive the data transferred according to the non-standard data transfer protocol;
wherein a first frequency of a first clock signal used by the circuit configured to convert is based at least on a second frequency of a clock signal of the non-standard data transfer protocol and on information relating to a filling of said first-in, first-out-type storage element.

19. The device according to claim 18, wherein said first frequency is additionally based on measured, determined, or predetermined information relating to the standard data transfer protocol, and wherein said measured information relating to the standard data transfer protocol is measured in the first apparatus and transferred to the second apparatus, via the non-standard channel, for use by the circuit configured to convert.

20. A method for transferring data from an electronic device, comprising:
converting, by a first conversion circuit, data transferred according to a first data transfer protocol to data transferred according to a second data transfer protocol;
wherein said first conversion circuit includes a first-in, first-out-type storage element configured to receive said data transferred according to the first data transfer protocol; and
adjusting a first frequency of a first clock signal used by the first conversion circuit based at least on a second frequency of a second clock signal of the data transferred according to the second data transfer protocol and on information relating to a filling of said first-in, first-out-type storage element.

21. The method according to claim 20, further comprising determining said information relating to the filling of said first-in, first-out-type storage element based on a filling rate and an output rate of said first-in, first-out-type storage element; wherein the first frequency is greater than the second frequency when said value relating to the filling of said first-in, first-out-type storage element is greater than a first threshold, and wherein the first frequency is less than the second frequency when said value relating to the filling of said first-in, first-out-type storage element is less than a second threshold.

22. The method according to claim 20, wherein the first frequency is based on the second frequency to which a value based on information relating to the filling of said first-in, first-out-type storage element is added or subtracted.

23. The method according to claim 20, wherein the first frequency is adjusted so that the first-in, first-out-type storage element is never empty and never full.
